(19) United States
(12) Patent Application Publication
(10) Pub. No.: US 2022/0035045 A1
(43) Pub. Date: Feb. 3, 2022

(54) EPHEMERIS DATA PROCESSING METHOD, ELECTRONIC DEVICE AND STORAGE MEDIUM

(71) Applicant: Beijing Baidu Netcom Science Technology Co., Ltd., Beijing (CN)

(72) Inventors: Guangdi SHAN, Beijing (CN); Hailu JIA, Beijing (CN); Xi CHEN, Beijing (CN); Lei XIA, Beijing (CN)

(21) Appl. No.: 17/450,968

(22) Filed: Oct. 14, 2021

(30) Foreign Application Priority Data
Feb. 5, 2021 (CN) 202110163761.9

(51) Int. Cl. G01S 19/25; G01S 19/08; G01S 19/27

(52) U.S. Cl. CPC G01S 19/258; G01S 19/256; G01S 19/27; G01S 19/08

(57) ABSTRACT

An ephemeris data processing method, electronic device and storage medium are disclosed, which relate to the fields of satellite communication, positioning, and navigation. The ephemeris data processing method includes: receiving raw ephemeris data from a plurality of user devices; analyzing the raw ephemeris data according to an analysis mode of each user device and a satellite ephemeris protocol of each galaxy. According to embodiments of the present disclosure, ephemeris data of a plurality of user devices can be centrally processed and stored, thereby storing more complete ephemeris data and then providing more abundant ephemeris data.

### CROSS-REFERENCE TO RELATED APPLICATION

This application claims priority to Chinese Patent Application No. 202110163761.9, filed on Feb. 5, 2021, which is hereby incorporated by reference in its entirety.

### TECHNICAL FIELD

The present disclosure relates to the technical field of computer technology, in particular to the technical fields of satellite communication, positioning, and navigation.

### BACKGROUND

Satellite ephemeris data includes radio signals emitted by positioning satellites, which are used to describe orbit information of each satellite. According to the ephemeris data, a position of each satellite can be calculated, and then positioning algorithms may be further applied to realize position calculation. The ephemeris data mainly includes broadcast ephemeris and precise ephemeris. The broadcast ephemeris is usually acquired by a receiver along with radio signals broadcast by a satellite, which has strong real-time performance. A satellite position calculated by using the precise ephemeris is more accurate, but the precise ephemeris generally requires post-processing of a satellite tracking station, and thus the real-time performance is poor. On a mobile phone, in a case that the ephemeris data cannot be obtained, positioning cannot be performed; and a speed of obtaining the ephemeris data also directly affects a speed of positioning.

### SUMMARY

Embodiments of the present disclosure provide an ephemeris data processing method, apparatus, device and storage medium.

According to one aspect of the present disclosure, an ephemeris data processing method is provided and includes:

receiving raw ephemeris data from a plurality of user devices; and

analyzing the raw ephemeris data according to an analysis mode of each user device and a satellite ephemeris protocol of each galaxy.

According to another aspect of the present disclosure, an ephemeris data processing method is provided and includes:

transmitting raw ephemeris data of a user device to a server, thereby enabling the server to analyze the raw ephemeris data according to an analysis mode of the user device and a satellite ephemeris protocol of each galaxy.

According to another aspect of the present disclosure, an ephemeris data processing apparatus is provided and includes:

a receiving module configured for receiving raw ephemeris data from a plurality of user devices; and

an analysis module configured for analyzing the raw ephemeris data according to an analysis mode of each user device and a satellite ephemeris protocol of each galaxy.

According to another aspect of the present disclosure, an ephemeris data processing apparatus is provided and includes:

a transmission module configured for transmitting raw ephemeris data of a user device to a server, thereby enabling the server to analyze the raw ephemeris data according to an analysis mode of the user device and a satellite ephemeris protocol of each galaxy.

According to another aspect of the present disclosure, an electronic device is provided and includes:

at least one processor; and

a memory communicatively connected to the at least one processor; wherein,

the memory stores instructions executable by the at least one processor to enable the at least one processor to implement the method of any one of embodiments of the present disclosure.

According to another aspect of the present disclosure, a non-transitory computer-readable storage medium is provided and includes computer instructions stored therein for causing a computer to perform the method of any one of embodiments of the present disclosure.

According to another aspect of the present disclosure, a computer program product is provided and includes a computer program which, when executed by a processor, implements the method of any one of embodiments of the present disclosure.

It is to be understood that the contents in this section are not intended to identify the key or critical features of the embodiments of the present disclosure, and are not intended to limit the scope of the present disclosure. Other features of the present disclosure will become readily apparent from the following description.

### BRIEF DESCRIPTION OF THE DRAWINGS

The drawings are included to provide a better understanding of the solution and are not to be construed as limiting the present disclosure. Wherein:

FIG. 1 is a schematic flowchart of an ephemeris data processing method according to an embodiment of the present disclosure;

FIG. 2a is a schematic diagram of an example of a navigation message;

FIG. 2b is a schematic diagram of an example of a format of a sub-frame in ephemeris data;

FIG. 2c is a schematic diagram of an example of plaintext ephemeris data;

FIG. 3 is a schematic flowchart of an ephemeris data processing method according to another embodiment of the present disclosure;

FIG. 4 is a schematic flowchart of an ephemeris data processing method according to another embodiment of the present disclosure;

FIG. 5 is a schematic flowchart of an ephemeris data processing method according to another embodiment of the present disclosure;

FIG. 6 is a schematic flowchart of an ephemeris data processing method according to another embodiment of the present disclosure;

FIG. 7 is a schematic diagram of an application example of an ephemeris data processing method according to another embodiment of the present disclosure;

FIG. 8 is a block diagram of an ephemeris data processing apparatus according to an embodiment of the present disclosure;

FIG. 9 is a block diagram of an ephemeris data processing apparatus according to another embodiment of the present disclosure;

FIG. 10 is a block diagram of an ephemeris data processing apparatus according to another embodiment of the present disclosure;

FIG. 11 is a block diagram of an ephemeris data processing apparatus according to another embodiment of the present disclosure; and

FIG. 12 is a block diagram of an electronic device for implementing an ephemeris data processing method according to an embodiment of the present disclosure.

### DETAILED DESCRIPTION

Reference will now be made in detail to the exemplary embodiments of the present disclosure, examples of which are illustrated in the accompanying drawings, wherein the various details of the embodiments of the present disclosure are included to facilitate understanding and are to be considered as exemplary only. Accordingly, a person skilled in the art should appreciate that various changes and modifications can be made to the embodiments described herein without departing from the scope and spirit of the present disclosure. Also, descriptions of well-known functions and structures are omitted from the following description for clarity and conciseness.

FIG. 1 is a schematic flowchart of an ephemeris data processing method according to an embodiment of the present disclosure. The method may include:

S11: receiving raw ephemeris data from a plurality of user devices; and

S12: analyzing the raw ephemeris data according to an analysis mode of each user device and a satellite ephemeris protocol of each galaxy.

For example, the method may be applied to a server side (which may also be referred to as a service side or a server). The server can receive raw ephemeris data from a plurality of user devices. The user device may include many types of devices, such as a mobile phone, a tablet computer, and a car. For example, the user device can communicate with a satellite, and can receive raw ephemeris data, such as ephemeris data in a binary format. For example, the user device may have positioning and/or navigation functions. For example, a map application (APP) may be installed in the user device of the Android system, and the map APP may have positioning and/or navigation functions. In the positioning and/or navigation process, the user device can communicate with the satellite and acquire required ephemeris data.

Ephemeris data obtained by a single user device may be less. Using crowdsourcing backhaul, the server can centrally process and store the ephemeris data of a plurality of user devices, thereby storing more complete ephemeris data and then providing more abundant ephemeris data. Further, in a case that the user device needs to perform positioning, even if the user device cannot communicate with the satellite, the user device can acquire required ephemeris data from the server, thereby improving positioning speed and positioning accuracy.

In another embodiment of the present disclosure, the ephemeris data processing method may include the various operations of the foregoing embodiment. In an implementation, the analysis mode of each user device includes: an interface definition of an operating system of each user device and a chip-layer ephemeris message data protocol.

In an implementation, S12 may include: analyzing the raw ephemeris data according to the interface definition of the operating system of each user device, the chip-layer ephemeris message data protocol and the satellite ephemeris protocol of each galaxy. Through the analysis of the raw ephemeris data, plaintext ephemeris data can be obtained, which is easier to apply to various scenarios that require plaintext ephemeris data.

In an implementation, the operating system of the user device may be the Android system. An example of the interface definition of the Android system may be: obtaining original message data of each satellite from getData( ) functions in GnssNavigationMessage (i.e., GNSS navigation information) class of the Android system. The message data is a binary byte array, and data formats of different galaxies are different. Specifically, for example, in data formats of satellite signals of GPS L1, Beidou D1, or Beidou D2, a sub-frame may contain 10 word segments each with a size of 30 bits. For another example, for satellite signals of Galileo I/NAV, a message is composed of a 238 bit word.

In the embodiments of the present disclosure, the full name of GNSS is Global Navigation Satellite System, which may generally refer to various satellite navigation systems, including global, regional and enhanced satellite navigation systems, such as Beidou satellite navigation system, Global Positioning System (GPS), Glonass, European Geostationary Navigation Overlay Service (EGNOS), Multi-Functional Satellite Augmentation System (MSAS), Quasi-Zenith Satellite System (QZSS). Examples of data obtained from the interface of the Android system are as follows:

### EXAMPLE 1

16,257,1,−1,2,34,−64,89,60,30,−11,−22,−108,18,1,−38,−84,11,−73,−121,−83,62,−44,−11, −76,1,−80,−127,−72,6,−79,−21,83,2,102,−88,83,3,62,−4,−50,23,74,−97,−21

The foregoing example is a piece of message data of a GPS satellite. After comma separation, the first data is a satellite number (16), the second data is a type (257, representing GPS), and the remaining data is data output from binary byte data. The specific meaning can be obtained through further analysis.

### EXAMPLE 2

18,769,1,1,13,110,65,−14,105,−21,116,−64,47,52,99,40

The foregoing example is message data of a GLONASS satellite. After comma separation, the first two digits are a satellite number (18) and a type (769, representing GLONASS), and the remaining data is data output from binary byte data. The specific meaning can be obtained through further analysis.

In one embodiment, for binary message data, specific format conversion may be performed for different chips and different satellite systems.

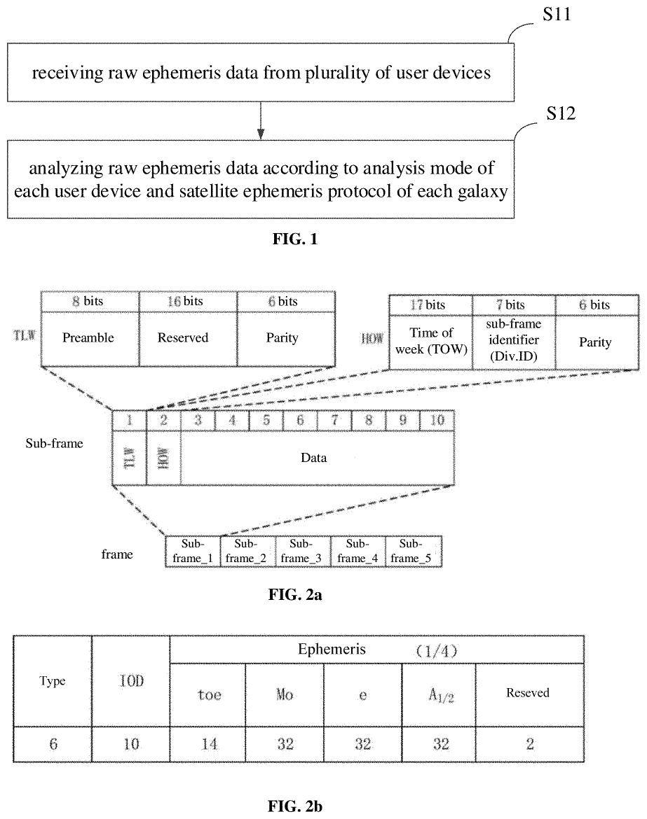

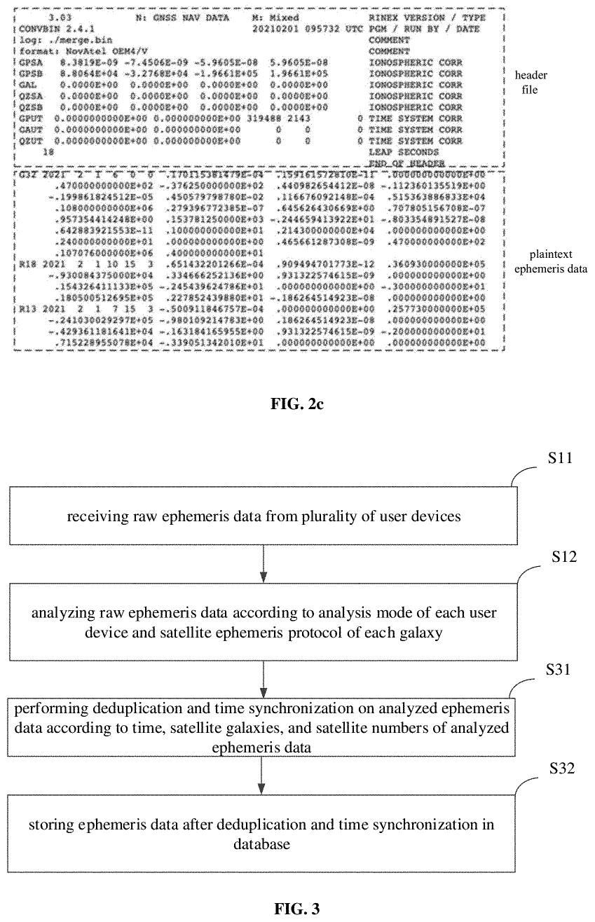

For example, referring to FIG. 2a, in a complete ephemeris of a GPS satellite, a navigation message may include multiple frames of data. One frame may include 1120 bits of data. One frame may be further divided into 5 sub-frames, and a length of each sub-frame is 300 bits. The sub-frame may include Telemetry word (TLW), Hand over word (HOW), and data. The telemetry word may include a preamble, reserved bits, and parity bits. The hand over word may include Time of week (TOW), sub-frame identifier (Div.ID), and parity bits. A piece of specific ephemeris data can be obtained by converting a binary value starting at a certain position and ending a certain position in a sub-frame, into a decimal system. For example, in sub-frame_1, starting from a certain position to the 10th position thereafter, is a GPS satellite week number; in a sub-frame_4, starting from a certain position to the 6th position thereafter, is a GPS satellite number.

For another example, ephemeris data of a Galileo satellite is composed of multiple sub-frames, and formats and data definitions are varied. FIG. 2b is an example of a format of one sub-frame in one piece of ephemeris data of the Galileo satellite. It is assumed that the sub-frame includes 128 bits, an ephemeris type can be analyzed out from the first 6 bits, issue of Data Ephemeris (IOD) can be analyzed out from 6 to 16 bits, reference time of ephemeris (TOE) can be analyzed out from 17 to 30 bits, mean anomaly at the reference time of the orbit (MO) can be analyzed out from the latter 32 bits. The sub-frame may further include A1/2 representing a square root of an orbit radius as well as reserved bits, etc.

In one embodiment, a format of plaintext ephemeris data of each galaxy may be determined according to the satellite ephemeris protocol of each galaxy. For example, referring to FIG. 2c, it shows an example of plaintext ephemeris data. In the plaintext ephemeris data, a part before “end of header” belongs to a header file. The header file explains a file type: GNSS NAV DATA, which means that this is broadcast ephemeris data; Mixed, which means that this data is a mixture of many satellite systems. After the header file, plaintext ephemeris data of specific GPS satellites are included. For example, in the eight rows of data starting from G32, the first row includes information such as a data type (G, representing GPS), a satellite number (32), and time stamp. The second row includes issue of data (IODE), amplitudes of harmonic correction of orbit radius Crs, and Δn (a difference between a satellite average angular velocity calculated by the precise ephemeris and an average angular velocity calculated according to given parameters), etc. The forgoing numerical values in FIG. 2c are not actually collected numerical values, and are merely illustrative of the format of plaintext ephemeris data, rather than limiting. In practical applications, according to the interface definition of the operating system of the user device, the chip-layer ephemeris message data protocol and the satellite ephemeris protocol of each galaxy, various raw ephemeris data can be analyzed to obtain various plaintext ephemeris data.

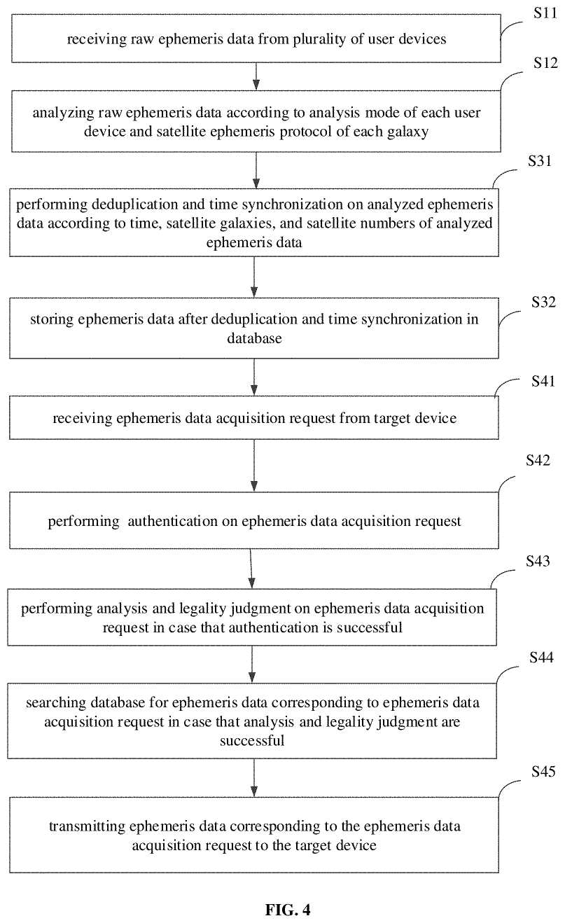

FIG. 3 is a schematic flowchart of an ephemeris data processing method according to another embodiment of the present disclosure. The ephemeris data processing method in this embodiment may include various operations of the foregoing embodiment. In one embodiment, the method further includes:

S31: performing deduplication and time synchronization on analyzed ephemeris data according to time, satellite galaxies, and satellite numbers of the analyzed ephemeris data; and

S32: storing ephemeris data after deduplication and time synchronization in a database.

For example, in a case that the analyzed ephemeris data includes multiple pieces of data with repeated time, satellite galaxies, and satellite numbers, one of the multiple pieces of data may be kept in the database. The database may be set in the server or set independently of the server.

For example, the time synchronization may be performed in a way including: every certain length of time, replacing ephemeris data previously stored in the database with ephemeris data with the latest time. For example, according to the time of the ephemeris data, ephemeris data analyzed at a current moment is used to replace last stored ephemeris data in the database. In this way, the ephemeris data with deduplication and the latest time can be stored in the database. In a case of searching for the ephemeris data, redundant data is less due to the deduplication, thereby improving search efficiency; further, latest ephemeris data can be found due to the time synchronization.

FIG. 4 is a schematic flowchart of an ephemeris data processing method according to another embodiment of the present disclosure. The ephemeris data processing method in this embodiment may include various operations of the foregoing embodiment. In one embodiment, the method further includes:

S41: receiving an ephemeris data acquisition request from a target device; and

S45: transmitting ephemeris data corresponding to the ephemeris data acquisition request to the target device.

By adopting the crowdsourcing backhaul method, the server can receive raw ephemeris data, such as ephemeris original message data, returned by a plurality of user devices such as mobile phone clients. The server analyzes the raw ephemeris data, and performs processing such as deduplication and time synchronization on the analyzed ephemeris data. The server stores de-duplicated and up-to-date data in the database, and maintains a data update synchronization mechanism. In this way, the server can support ephemeris data service of the user device. In a case that the server receives an ephemeris data acquisition request from a certain user device, i.e., a target device, the server can search the database for ephemeris data corresponding to the ephemeris data acquisition request. For example, in a case that the ephemeris data acquisition request includes a time period that needs to be searched, ephemeris data within the time period can be searched in the database. For another example, in a case that the ephemeris data acquisition request includes a satellite galaxy to be searched, ephemeris data including the satellite galaxy can be searched in the database. For another example, in a case that the ephemeris data acquisition request includes a satellite number to be searched, ephemeris data including the satellite number can be searched in the database.

The server can transmit ephemeris data to the target device based on the ephemeris data acquisition request, provide accurate and timely ephemeris data services, thereby providing data support for positioning, navigation and other functions, and then improving speed and accuracy of positioning and navigation.

In an implementation, the ephemeris data corresponding to the ephemeris data acquisition request includes ephemeris data of all galaxies or ephemeris data of a specific galaxy.

For example, in a case that the ephemeris data acquisition request includes a specific satellite galaxy (referred to as a specific galaxy), ephemeris data including the specific galaxy may be searched in the database. Then, the server can return ephemeris data of the specific galaxy to the target device. In a case that the ephemeris data acquisition request does not include a specific galaxy, ephemeris data of all galaxies may be searched in the database. Then, the server can return ephemeris data of all galaxies to the target device. Therefore, a variety of ephemeris data services can be provided accurately and timely, thereby flexibly providing data support for functions such as positioning and navigation, and then improving the speed and accuracy of positioning and navigation.

In an implementation, the method further includes:

S42: performing an authentication on the ephemeris data acquisition request;

S43: performing analysis and legality judgment on the ephemeris data acquisition request in a case that the authentication is successful; and

S44: searching the database for ephemeris data corresponding to the ephemeris data acquisition request in a case that the analysis and legality judgment are successful.

For example, after receiving the ephemeris data acquisition request from the target device in S41, the server may use device information and/or user information carried in the ephemeris data acquisition request for authentication to determine whether the ephemeris data acquisition request is from an authorized device and/or authorized user. In a case that the ephemeris data acquisition request is from an authorized device and/or authorized user, it can be determined that the authentication is successful. In a case that the authentication is successful, the server may perform analysis on the ephemeris data acquisition request to acquire requested content such as time, satellite galaxy, and satellite number. Further, the server may perform legality judgment on the content obtained after the analysis. For example, the server may judge whether a satellite galaxy complies with a galaxy name rule, and whether a satellite number complies with a numbering rule. In a case that the authentication is unsuccessful, the server may stop subsequent operations and the service for obtaining ephemeris data this time fails. The server may return failure response information to the target device. The server may not return information, and the target device determines whether the service for obtaining ephemeris data is successful or unsuccessful according to whether it has timed out.

After the ephemeris data acquisition request is successfully analyzed, legality judgment may be performed on the analyzed content. After the legality judgment is successful, the server may search the database for ephemeris data corresponding to the ephemeris data acquisition request. Then, in S45, the server may return the searched ephemeris data corresponding to the ephemeris data acquisition request to the target device. In this way, the security of the service for obtaining ephemeris data can be improved.

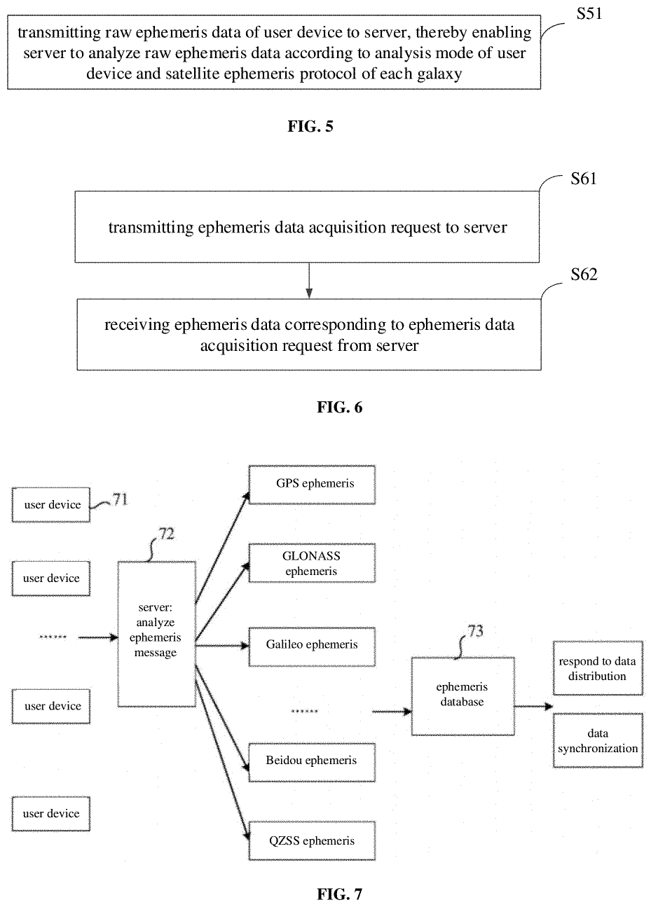

FIG. 5 is a schematic flowchart of an ephemeris data processing method according to another embodiment of the present disclosure. The method may include the following operations.

S51: transmitting raw ephemeris data of a user device to a server, thereby enabling the server to analyze the raw ephemeris data according to an analysis mode of the user device and a satellite ephemeris protocol of each galaxy.

For example, the method may be applied to a user device (which may also be referred to as a client or a user device). The user device may include many types of devices, such as a mobile phone, a tablet computer, and a car. For example, the user device can communicate with a satellite, and can receive raw ephemeris data, such as ephemeris data in a binary format. For example, the user device may have positioning and/or navigation functions.

By adopting the crowdsourcing backhaul method, a plurality of user devices can transmit their own raw ephemeris data to the server. The server can centrally process and store the raw ephemeris data, thereby storing more complete ephemeris data and then providing more abundant ephemeris data. Specific manner in which the server processes the raw ephemeris data, may refer to the relevant description of the foregoing embodiment applied to the server, which will not be repeated here.

FIG. 6 is a schematic flowchart of an ephemeris data processing method according to another embodiment of the present disclosure. The ephemeris data processing method in this embodiment may include various operations of the foregoing embodiment. In one embodiment, the method further includes:

S61: transmitting an ephemeris data acquisition request to a server; and

S62: receiving ephemeris data corresponding to the ephemeris data acquisition request from the server.

For example, the ephemeris data acquisition request may carry device information and/or user information, etc., and the server may perform an authentication on the ephemeris data acquisition request to determine whether the ephemeris data acquisition request is from an authorized device and/or authorized user. After the server performs authentication, analysis and legality judgment on the ephemeris data acquisition request, the server searches the database for ephemeris data corresponding to the ephemeris data acquisition request. Specific search method may refer to the relevant description of the foregoing embodiment applied to the server, which will not be repeated here. Then, the server may return the searched ephemeris data corresponding to the ephemeris data acquisition request to the target device. In this way, the user device can receive the ephemeris data corresponding to the ephemeris data acquisition request returned by the server.

The user device can receive the ephemeris data transmitted by the server based on the ephemeris data acquisition request, obtain the ephemeris data service in an accurate and timely manner, thereby providing data support for positioning, navigation and other functions, and then improving speed and accuracy of positioning and navigation. The user device that reports the ephemeris data to the server may be different from the user device that requests the server to issue the ephemeris data.

In an implementation, the ephemeris data corresponding to the ephemeris data acquisition request includes ephemeris data of all galaxies or ephemeris data of a specific galaxy.

For example, in a case that the ephemeris data acquisition request includes a specific galaxy, the server may search the database for ephemeris data including the specific galaxy. Then, the user device can receive ephemeris data of the specific galaxy returned by the server. In a case that the ephemeris data acquisition request does not include a specific galaxy, ephemeris data of all galaxies may be searched in the database. Then, the user device can receive ephemeris data of all galaxies returned by the server. Therefore, a variety of ephemeris data services can be provided accurately and timely, thereby flexibly providing data support for functions such as positioning and navigation, and then improving the speed and accuracy of positioning and navigation.

In an application example, the operating system of the user device such as a mobile phone, may be an Android system. Some versions of Android system support transmission of raw data related to satellite positioning from a bottom layer of the mobile phone through an interface to an application layer for developers to use. These raw data may be further converted into observation data required for satellite positioning, such as pseudo-range, carrier phase, and signal-to-noise ratio of each satellite. After obtaining these data, developers may independently develop positioning algorithms for user device such as mobile phones without relying on the chip-level positioning results, so as to achieve higher-precision satellite positioning.

User device such as mobile phone terminal self-developed satellite positioning requires satellite ephemeris data in addition to observations data thrown by the mobile phone. The satellite ephemeris data may include radio signals transmitted by positioning satellites to describe orbital information of each satellite. After obtaining the ephemeris data, a position of each satellite can be calculated, and the positioning algorithm can be further applied to realize position calculation. The ephemeris data is mainly divided into broadcast ephemeris and precise ephemeris.

For example, methods of obtaining the raw ephemeris data on the mobile phone includes at least one of the following.

Method 1: acquiring broadcast ephemeris through an interface opened by the Android system, such as GnssNavigationMessage (GNSS navigation information) interface.

Method 2: obtaining, by the mobile phone, precise ephemeris data of organizations such as International GNSS Service (IGS) through the internet; where the precise ephemeris data is generally generated in way that after the ephemeris data is obtained by multiple ground satellite tracking stations, the multiple ground satellite tracking stations perform post-processing such as aggregation and combined inverse calculation the ephemeris data.

Method 3: obtaining, by the mobile phone, the raw ephemeris data through Assisted-GNSS (AGNSS) service provider.

Therefore, after obtaining the raw ephemeris data in various ways, the ephemeris data of various satellites of a plurality of user devices such as mobile phones may be uploaded to the server for centralized processing, thereby reducing the time for collecting ephemeris data of various satellites of each galaxy. Later, the mobile phone can obtain required ephemeris data from the server, thereby improving the positioning speed.

The ephemeris data processing method provided in the present disclosure is an ephemeris service method based on user device crowdsourcing, which can realize low-cost, strong real-time, high stability and complete ephemeris data acquisition and distribution services. By realizing complete, timely and stable ephemeris data services at low cost, rapid positioning and self-developed high-precision positioning algorithms can further be realized on the user device.

In an example, a mobile phone that supports transmitting and broadcasting ephemeris through the GnssNavigationMessage interface, can be used to transmit raw ephemeris data such as ephemeris original message data (which may be referred to as original messages, ephemeris message, etc.) in real time to the server. The server performs processing such as original message calculation, ephemeris data collection and time synchronization, and finally realizes a service that supports ephemeris aggregation and delivery. This technology uses crowdsourcing to solve the problem of insufficient data in the traditional way of obtaining broadcast ephemeris only relying on a single machine. The framework for real-time acquisition, aggregation, and delivery of this technology further supports real-time ephemeris services with a short latency, such as a latency of no more than 1 second, which is much faster than the precise ephemeris that relies on post-calculation.

The ephemeris data processing method in this embodiment may include: crowdsourcing backhaul, analysis of ephemeris original messages of all galaxies, data storage and synchronization, and data distribution.

(1) Crowdsourcing Backhaul

Referring to FIG. 7, a user device 71, such as a mobile phone terminal, acquires ephemeris original message information in real time through a specific interface such as GnssNavigationMessage interface of the Android system. The user device may also be referred to as a client. The client may perform preliminary data integrity and validity verification and preliminary aggregation on raw ephemeris data. In a case that a certain level of legal data is acquired, the legal data is uniformly returned to the server for further processing. For example, in a case that raw ephemeris data in a certain user device reaches a certain data volume threshold, the raw ephemeris data is uniformly returned to the server for further processing. For another example, in a case that a collection time of raw ephemeris data in a certain user device reaches a certain length of time, the raw ephemeris data is uniformly returned to the server for further processing.

(2) Analysis of Ephemeris Original Messages of All Galaxies

After the server 72 acquires the original messages (such as binary messages) returned by many mobile phone clients, the server performs analysis on the original messages according to the interface definition of the Android system, the chip-layer ephemeris message data protocol, and the satellite ephemeris protocol of each galaxy. The binary message transmitted by the satellite to the mobile phone is analyzed into plaintext ephemeris data on the server. The server can analyze different types of ephemeris, such as GPS ephemeris, GLONASS ephemeris, Galileo ephemeris, Beidou ephemeris, QZSS ephemeris.

(3) Data Storage and Synchronization

After each piece of returned data is analyzed, the server performs deduplication and time synchronization on analyzed ephemeris data according to time, satellite galaxies, and satellite numbers of the analyzed ephemeris data. In addition, the server can store the de-duplicated and up-to-date data in a database. The database may be referred to as an ephemeris database 73. Further, the server can maintain a data update synchronization mechanism. Based on the ephemeris database, data synchronization can be realized, and the serve can respond to data distribution.

(4) Data Distribution

In a case that the client needs to accelerate the positioning speed or perform high-precision satellite positioning calculation, the client can first initiate a request for pulling ephemeris data (or referred to as an ephemeris data acquisition request) to an crowdsourced ephemeris data service of the server. After completing authentication, request analysis, and legality judgment, the server queries the database data, and returns ephemeris data of all galaxies or a specific galaxy in time to support the client's needs.

With the technical solution of the present disclosure, the user device can quickly and accurately obtain ephemeris data from the server, which helps to realization of self-developed positioning algorithms; and with the ephemeris data of all galaxies issued by the service, the positioning speed and positioning accuracy can be greatly improved as compared with the chip positioning results. In scenarios where the satellite cannot be connected or the satellite signal is poor, the accuracy of positioning and navigation can be assured.

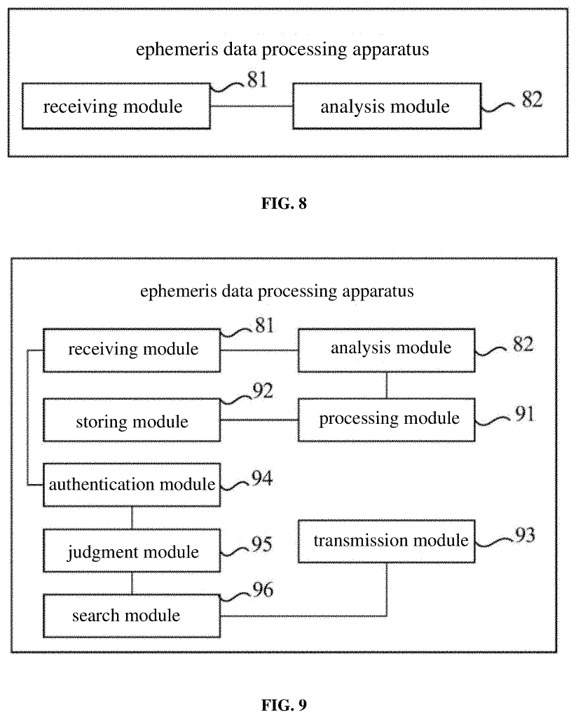

FIG. 8 is a block diagram of an ephemeris data processing apparatus according to an embodiment of the present disclosure. The apparatus may include:

a receiving module 81 configured for receiving raw ephemeris data from a plurality of user devices;

an analysis module 82 configured for analyzing the raw ephemeris data according to an analysis mode of each user device and a satellite ephemeris protocol of each galaxy.

For example, the apparatus may be applied to a server, and implementation modes of specific functions of each module of the apparatus may refer to the related description about the server or the service side in the foregoing embodiment.

FIG. 9 is a block diagram of an ephemeris data processing apparatus according to an embodiment of the present disclosure. The ephemeris data processing apparatus in this embodiment may include various components of the foregoing apparatus embodiment. In an implementation, the analysis mode of each user device includes: an interface definition of an operating system of each user device and a chip-layer ephemeris message data protocol.

In an embodiment, the apparatus further includes:

a processing module 91 configured for performing deduplication and time synchronization on analyzed ephemeris data according to time, satellite galaxies, and satellite numbers of the analyzed ephemeris data;

a storing module 92 configured for storing ephemeris data after deduplication and time synchronization in a database.

In an embodiment, the receiving module 81 is further configured for receiving an ephemeris data acquisition request from a target device.

The apparatus further includes: a transmission module 93, configured for transmitting ephemeris data corresponding to the ephemeris data acquisition request to the target device.

In an embodiment, the ephemeris data corresponding to the ephemeris data acquisition request includes ephemeris data of all galaxies or ephemeris data of a specific galaxy.

In an embodiment, the apparatus further includes:

an authentication module 94 configured for performing an authentication on the ephemeris data acquisition request;

a judgment module 95 configured for performing analysis and legality judgment on the ephemeris data acquisition request in a case that the authentication is successful;

a search module 96 configured for searching the database for ephemeris data corresponding to the ephemeris data acquisition request in a case that the analysis and legality judgment are successful.

For example, the apparatus may be applied to a server, and implementation modes of specific functions of each module of the apparatus may refer to the related description about the server or the service side in the foregoing embodiment.

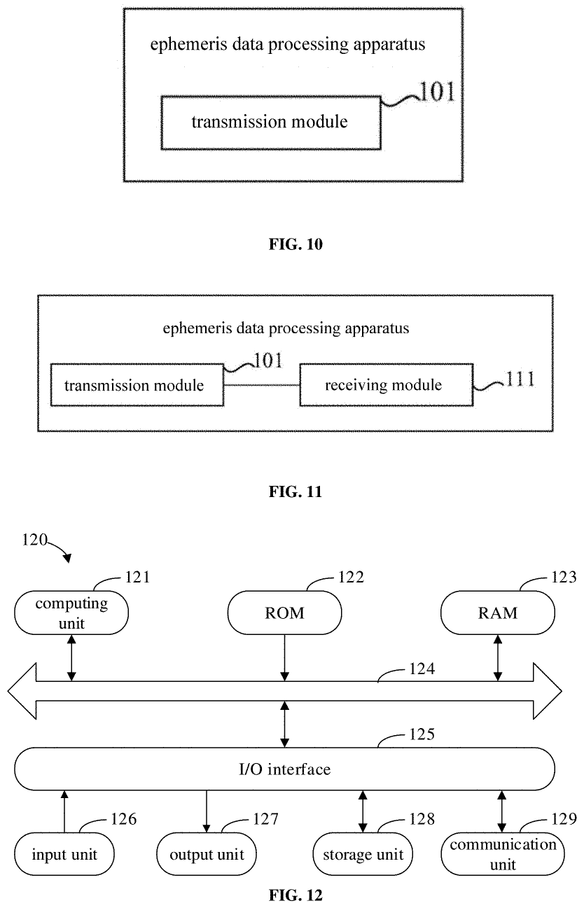

FIG. 10 is a block diagram of an ephemeris data processing apparatus according to an embodiment of the present disclosure. The apparatus may include:

a transmission module 101 configured for transmitting raw ephemeris data of a user device to a server, thereby enabling the server to analyze the raw ephemeris data according to an analysis mode of the user device and a satellite ephemeris protocol of each galaxy.

For example, the apparatus may be applied to a user device, and implementation modes of specific functions of each module of the apparatus may refer to the related description about the user device or the client in the foregoing embodiment.

FIG. 11 is a block diagram of an ephemeris data processing apparatus according to an embodiment of the present disclosure. The ephemeris data processing apparatus in this embodiment may include various components of the foregoing apparatus embodiment. In an implementation, the transmission module 101 is further configured for transmitting an ephemeris data acquisition request to a server.

The apparatus further includes: a receiving module 111 configured for receiving ephemeris data corresponding to the ephemeris data acquisition request from the server.

For example, the apparatus may be applied to a user device, and implementation modes of specific functions of each module of the apparatus may refer to the related description about the user device or the client in the foregoing embodiment.

Functions of various units, modules or sub-modules in the apparatus in the embodiments of the present disclosure may refer to the corresponding description in the foregoing method embodiments, which are not described herein again.

According to the embodiments of the present disclosure, the present disclosure further provides an electronic device, a readable storage medium and a computer program product.

FIG. 12 is a block diagram of an electronic device 120 for implementing an ephemeris data processing method according to an embodiment of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processing, cellular telephones, smart phones, wearable devices, and other similar computing devices. The components shown herein, their connections and relationships, and their functions are by way of example only and are not intended to limit the implementations of the present disclosure described and/or claimed herein.

As shown in FIG. 12, the electronic device 120 includes a computing unit 121. The computing unit 121 may carry out various suitable actions and processes according to a computer program stored in a read-only memory (ROM) 122 or a computer program loaded from a storage unit 128 into a random access memory (RAM) 123. The RAM 123 may as well store therein all kinds of programs and data required for the operation of the device 120. The computing unit 121, the ROM 122 and the RAM 123 are connected to each other through a bus 124. An input/output (I/O) interface 125 is also connected to the bus 124.

Multiple components in the device 120 are connected to the I/O interface 125. The multiple components include: an input unit 126, e.g., a keyboard, a mouse and the like; an output unit 127, e.g., a variety of displays, loudspeakers, and the like; a storage unit 128, e.g., a magnetic disk, an optical disc and the like; and a communication unit 129, e.g., a network card, a modem, a wireless transceiver, and the like. The communication unit 129 allows the device 120 to exchange information/data with other devices through a computer network, such as the Internet, and/or other telecommunication networks.

The computing unit 121 may be any general purpose and/or special purpose processing components having a processing and computing capability. Some examples of the computing unit 121 include, but are not limited to: a central processing unit (CPU), a graphic processing unit (GPU), various special purpose artificial intelligence (AI) computing chips, various computing units running a machine learning model algorithm, a digital signal processor (DSP), and any suitable processor, controller, microcontroller, etc. The computing unit 121 carries out the aforementioned methods and processes, e.g., the ephemeris data processing method. For example, in some embodiments, the ephemeris data processing method may be implemented as a computer software program tangibly embodied in a machine readable medium, such as the storage unit 128. In some embodiments, all or a part of the computer program may be loaded to and/or installed on the device 120 through the ROM 122 and/or the communication unit 129. When the computer program is loaded into the RAM 123 and executed by the computing unit 121, one or more operations of the foregoing ephemeris data processing method may be implemented. Optionally, in other embodiments, the computing unit 121 may be configured in any other suitable manner (e.g., by means of a firmware) to implement the ephemeris data processing method.

Various implementations of the aforementioned systems and techniques may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), a computer hardware, a firmware, a software, and/or a combination thereof. The various implementations may include an implementation in form of one or more computer programs. The one or more computer programs may be executed and/or interpreted on a programmable system including at least one programmable processor. The programmable processor may be a special purpose or general purpose programmable processor, may receive data and instructions from a storage system, at least one input device and at least one output device, and may transmit data and instructions to the storage system, the at least one input device and the at least one output device.

Program codes for implementing the methods of the present disclosure may be written in one programming language or any combination of multiple programming languages. These program codes may be provided to a processor or controller of a general purpose computer, a special purpose computer, or other programmable data processing device, such that the functions/operations specified in the flow diagram and/or block diagram are implemented when the program codes are executed by the processor or controller. The program codes may be run entirely on a machine, run partially on the machine, run partially on the machine and partially on a remote machine as a standalone software package, or run entirely on the remote machine or server.

In the context of the present disclosure, the machine readable medium may be a tangible medium, and may include or store a program used by an instruction execution system, device or apparatus, or a program used in conjunction with the instruction execution system, device or apparatus. The machine readable medium may be a machine readable signal medium or a machine readable storage medium. The machine readable medium includes, but is not limited to: an electronic, magnetic, optical, electromagnetic, infrared, or semiconductor system, device or apparatus, or any suitable combination thereof. A more specific example of the machine readable storage medium includes: an electrical connection based on one or more wires, a portable computer disk, a hard disk, a random access memory (RAM), a read only memory (ROM), an erasable programmable read only memory (EPROM or flash memory), an optic fiber, a portable compact disc read only memory (CD-ROM), an optical storage device, a magnetic storage device, or any suitable combination thereof.

To facilitate user interaction, the system and technique described herein may be implemented on a computer. The computer is provided with a display device (for example, a cathode ray tube (CRT) or liquid crystal display (LCD) monitor) for displaying information to a user, a keyboard and a pointing device (for example, a mouse or a track ball). The user may provide an input to the computer through the keyboard and the pointing device. Other kinds of devices may be provided for user interaction, for example, a feedback provided to the user may be any manner of sensory feedback (e.g., visual feedback, auditory feedback, or tactile feedback); and input from the user may be received by any means (including sound input, voice input, or tactile input).

The system and technique described herein may be implemented in a computing system that includes a back-end component (e.g., as a data server), or that includes a middle-ware component (e.g., an application server), or that includes a front-end component (e.g., a client computer having a graphical user interface or a Web browser through which a user can interact with an implementation of the system and technique), or any combination of such back-end, middleware, or front-end components. The components of the system can be interconnected by any form or medium of digital data communication (e.g., a communication network). Examples of communication networks include a local area network (LAN), a wide area network (WAN), and the Internet.

The computer system can include a client and a server. The client and server are generally remote from each other and typically interact through a communication network. The relationship of client and server arises by virtue of computer programs running on respective computers and having a client-server relationship to each other.

It is appreciated, all forms of processes shown above may be used, and operations thereof may be reordered, added or deleted. For example, as long as expected results of the technical solutions of the present disclosure can be achieved, operations set forth in the present disclosure may be performed in parallel, performed sequentially, or performed in a different order, and there is no limitation in this regard.

The foregoing specific implementations constitute no limitation on the scope of the present disclosure. It is appreciated by those skilled in the art, various modifications, combinations, sub-combinations and replacements may be made according to design requirements and other factors. Any modifications, equivalent replacements and improvements made without deviating from the spirit and principle of the present disclosure shall be deemed as falling within the scope of the present disclosure.

What is claimed is:

1. An ephemeris data processing method, comprising:
receiving raw ephemeris data from a plurality of user devices; and
analyzing the raw ephemeris data according to an analysis mode of each user device and a satellite ephemeris protocol of each galaxy.

2. The method of claim 1, wherein the analysis mode of each user device comprises:
an interface definition of an operating system of each user device and a chip-layer ephemeris message data protocol.

3. The method of claim 1, the method further comprises:
performing deduplication and time synchronization on analyzed ephemeris data according to time, satellite galaxies, and satellite numbers of the analyzed ephemeris data; and
storing ephemeris data after deduplication and time synchronization in a database.

4. The method of claim 1, the method further comprises:
receiving an ephemeris data acquisition request from a target device; and
transmitting ephemeris data corresponding to the ephemeris data acquisition request to the target device.

5. The method of claim 4, wherein the ephemeris data corresponding to the ephemeris data acquisition request comprises ephemeris data of all galaxies or ephemeris data of a specific galaxy.

6. The method of claim 4, the method further comprises:
performing an authentication on the ephemeris data acquisition request;
performing analysis and legality judgment on the ephemeris data acquisition request in a case that the authentication is successful; and
searching the database for ephemeris data corresponding to the ephemeris data acquisition request in a case that the analysis and legality judgment are successful.

7. An ephemeris data processing method, comprising:
transmitting raw ephemeris data of a user device to a server, thereby enabling the server to analyze the raw ephemeris data according to an analysis mode of the user device and a satellite ephemeris protocol of each galaxy.

8. The method of claim 7, the method further comprises:
transmitting an ephemeris data acquisition request to the server; and
receiving ephemeris data corresponding to the ephemeris data acquisition request from the server.

9. An electronic device, comprising:
at least one processor; and
a memory communicatively connected to the at least one processor; wherein,
the memory stores instructions executable by the at least one processor to enable the at least one processor to perform operations of:
receiving raw ephemeris data from a plurality of user devices; and
analyzing the raw ephemeris data according to an analysis mode of each user device and a satellite ephemeris protocol of each galaxy.

10. The electronic device of claim 9, wherein the analysis mode of each user device comprises: an interface definition of an operating system of each user device and a chip-layer ephemeris message data protocol.

11. The electronic device of claim 9, wherein the instructions are executable by the at least one processor to enable the at least one processor further to perform operations of:
performing deduplication and time synchronization on analyzed ephemeris data according to time, satellite galaxies, and satellite numbers of the analyzed ephemeris data; and
storing ephemeris data after deduplication and time synchronization in a database.

12. The electronic device of claim 9, wherein the instructions are executable by the at least one processor to enable the at least one processor further to perform operations of:
receiving an ephemeris data acquisition request from a target device; and
transmitting ephemeris data corresponding to the ephemeris data acquisition request to the target device.

13. The electronic device of claim 12, wherein the ephemeris data corresponding to the ephemeris data acquisition request comprises ephemeris data of all galaxies or ephemeris data of a specific galaxy.

14. The electronic device of claim 12, wherein the instructions are executable by the at least one processor to enable the at least one processor further to perform operations of:
performing an authentication on the ephemeris data acquisition request;
performing analysis and legality judgment on the ephemeris data acquisition request in a case that the authentication is successful; and
searching the database for ephemeris data corresponding to the ephemeris data acquisition request in a case that the analysis and legality judgment are successful.

15. An electronic device, comprising:
at least one processor; and
a memory communicatively connected to the at least one processor; wherein,
the memory stores instructions executable by the at least one processor to enable the at least one processor to perform operation of:
transmitting raw ephemeris data of a user device to a server, thereby enabling the server to analyze the raw ephemeris data according to an analysis mode of the user device and a satellite ephemeris protocol of each galaxy.

16. The electronic device of claim 15, wherein the instructions are executable by the at least one processor to enable the at least one processor further to perform operations of:
transmitting an ephemeris data acquisition request to the server; and
receiving ephemeris data corresponding to the ephemeris data acquisition request from the server.

17. A non-transitory computer-readable storage medium storing computer instructions for causing a computer to perform operations of:
receiving raw ephemeris data from a plurality of user devices; and
analyzing the raw ephemeris data according to an analysis mode of each user device and a satellite ephemeris protocol of each galaxy.

18. The non-transitory computer-readable storage medium of claim 17, wherein the analysis mode of each user device comprises: an interface definition of an operating system of each user device and a chip-layer ephemeris message data protocol.

19. The non-transitory computer-readable storage medium of claim 17, wherein the computer instructions are further configured for causing the computer to perform operations of:
performing deduplication and time synchronization on analyzed ephemeris data according to time, satellite galaxies, and satellite numbers of the analyzed ephemeris data; and
storing ephemeris data after deduplication and time synchronization in a database.

20. A non-transitory computer-readable storage medium storing computer instructions for causing a computer to perform operation of:
transmitting raw ephemeris data of a user device to a server, thereby enabling the server to analyze the raw ephemeris data according to an analysis mode of the user device and a satellite ephemeris protocol of each galaxy.
